(19) United States
(12) Patent Application Publication
(10) Pub. No.: US 2011/0281465 A1
(43) Pub. Date: Nov. 17, 2011

(54) ELECTRICAL CONNECTOR ASSEMBLY WITH AN IMPROVED SHELL

(75) Inventor: LI-CHUN HOU, Kunshan (CN)

(73) Assignee: HON HAI PRECISION INDUSTRY CO., LTD., New Taipei (TW)

(21) Appl. No.: 13/105,936

(22) Filed: May 12, 2011

(30) Foreign Application Priority Data
May 12, 2010 (CN) 201020186369.3

(51) Int. Cl. H01R 13/648

(52) U.S. Cl. 439/607.55

(57) ABSTRACT

An electrical connector assembly (100) includes an insulative housing (1) with a plurality of terminal passages (12), a plurality of contacts (2) received in the corresponding terminal passages, and a shell (5) enclosing the insulative housing. The shell includes a top shell (52) and a bottom shell (51) assembled with each other, the top shell includes a body portion (521) in the front thereof and a sleeve portion (523) extending backwards from the body portion, the body portion has an upper wall (5210), a rear wall (5213) connected with the upper wall and vertical to the upper wall, and a pair of lateral walls (5212) on both sides of the upper wall and perpendicular to the upper wall, the sleeve portion (523) is extending rearwards from the rear wall (5213) to form a close configuration with four conjoint walls.

### BACKGROUND OF THE INVENTION

1. FIELD OF THE INVENTION

The present invention generally relates to an electrical connector assembly, and more particularly to an electrical connector assembly used for high definition signal transmission.

2. DESCRIPTION OF RELATED ART

Developed by Sony, Hitachi, Thomson (RCA), Philips, Matsushita (Panasonic), Toshiba and Silicon Image, the High-Definition Multimedia Interface (HDMI) has emerged as the connection standard for HDTV and the consumer electronics market. HDMI is the first digital interface to combine uncompressed high-definition video, multi-channel audio and intelligent format and command data in a single digital interface.

An electrical connector in accordance with HDMI standard comprises an insulative housing, a number of contacts received in the insulative housing, and a metallic shell shielding the insulative housing. U.S. Pat. No. 7,252,548B2 issued to Huang on Aug. 7, 2007 discloses an electrical connector compatible with HDMI transmitting protocol, the electrical connector has a shielding member with a first shell and a second shell, the first shell and the second shell are assembled to each other along an up-to-down direction to enclose a electrical connection between contacts and a cable, and the first shell and the second shell are crimping and supporting the cable, however gaps may be occurred after assembly, rear segments of the first shell and the second are shielded insufficiently, and Electro-Magnetic Interference (EMI) can't be suppressed enough.

Correspondingly, it is desired to have an electrical connector assembly with improved shell to address the problems stated above.

### BRIEF SUMMARY OF THE INVENTION

Accordingly, an object of the present invention is to provide an electrical connector assembly having an improved shell for suppressing Electro-Magnetic Interference (EMI).

In order to achieve the above-mentioned object, an electrical connector assembly in accordance with the present invention comprises an insulative housing with a plurality of terminal passages, a plurality of contacts received in the corresponding terminal passages, and a shell enclosing the insulative housing. The shell includes a top shell and a bottom shell assembled with each other, the top shell includes a body portion in the front thereof and a sleeve portion extending backwards from the body portion, the body portion has an upper wall, a rear wall connected with the upper wall and vertical to the upper wall, and a pair of lateral walls on both sides of the upper wall and perpendicular to the upper wall, the sleeve portion is extending rearwards from the rear wall to form a close configuration with four conjoint walls.

Other objects, advantages and novel features of the invention will become more apparent from the following detailed description of the present embodiment when taken in conjunction with the accompanying drawings.

### BRIEF DESCRIPTION OF THE DRAWINGS

FIG. 1 is an assembled, perspective view of an electrical connector assembly of the present invention;

FIG. 2 is similar to FIG. 1, but viewed from another aspect;

FIG. 3 is an exploded, perspective view of the electrical connector assembly shown in FIG. 1;

FIG. 4 is similar to FIG. 3, but viewed from another aspect;

FIG. 5 is a partially assembled, perspective view of the electrical connector assembly shown in FIG. 3;

FIG. 6 is similar to FIG. 5, but viewed from another aspect;

FIG. 7 is a further assembled, perspective view of the electrical connector assembly shown in FIG. 5; and

FIG. 8 is a further assembled, perspective view of the electrical connector assembly shown in FIG. 7.

### DETAILED DESCRIPTION OF THE INVENTION

Reference will now be made to the drawing figures to describe the present invention in detail.

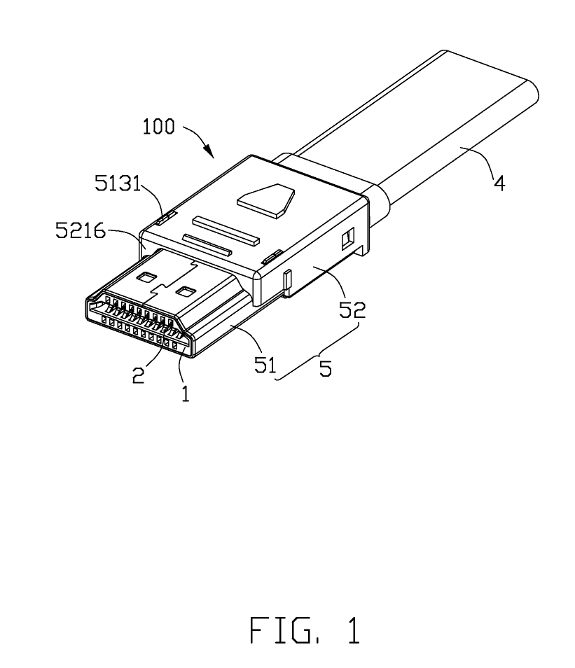

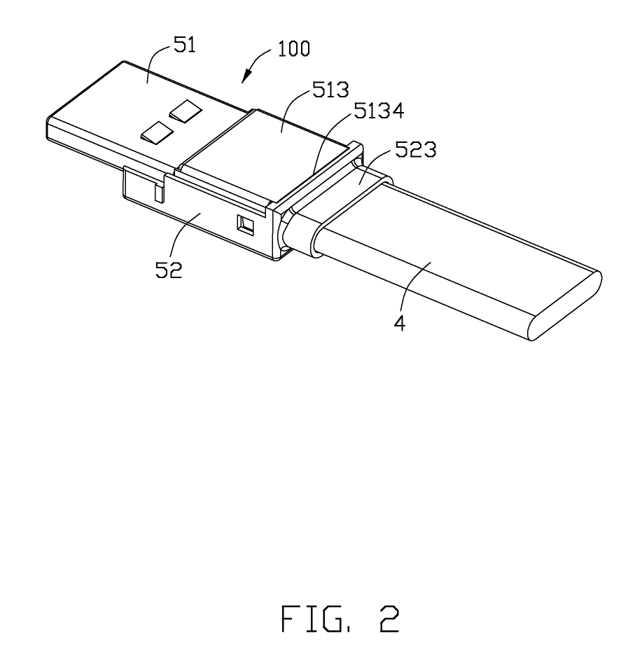

Referring to FIGS. 1-3, an electrical connector assembly 100 in accordance with the present invention comprises an insulative housing 1, a plurality of contacts 2 received in the insulative housing 1, a spacer 3 assembled to a back end of the insulative housing 1, a metallic shell 5 and a cable 4 with a plurality of wires 41.

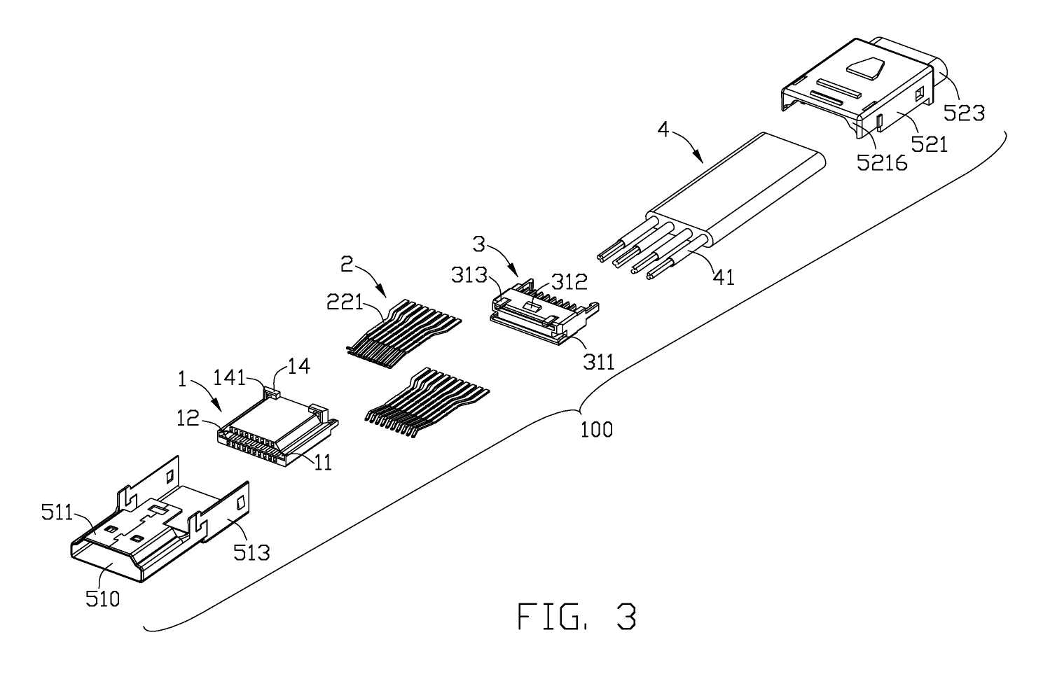

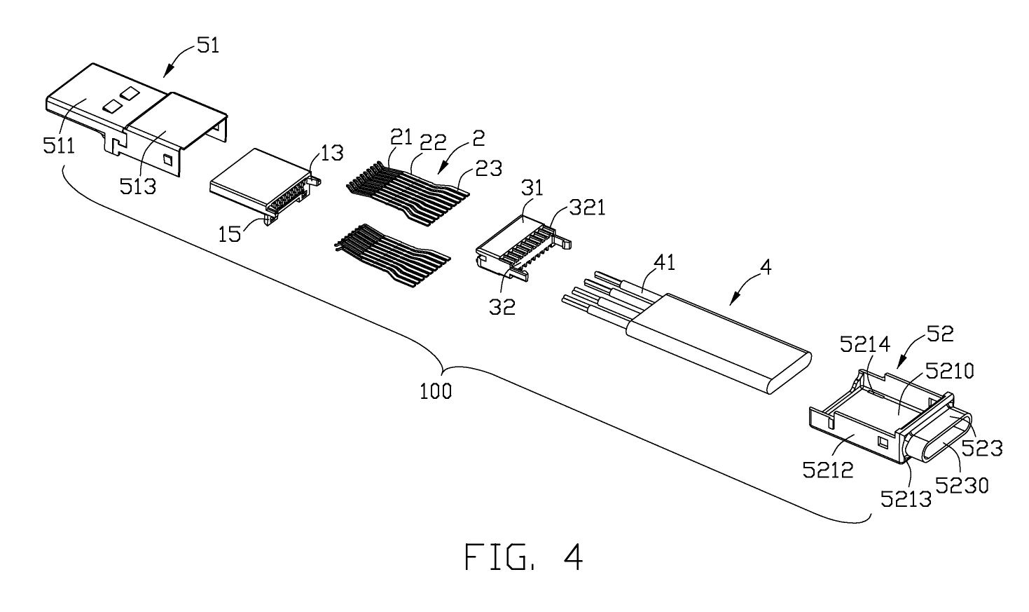

Referring to FIGS. 3-8, the insulative housing 1 comprises a trapezoid space 11 formed by four walls in the front for receiving a complementary connector (not shown), and two rows of terminal passages 12 formed in upper and bottom walls of the insulative housing 1 and communicate with the trapezoid space 11 to receive the contacts 2. A connecting face 15 is defined on a back end of the insulative housing 1, and a pair of positioning legs 13 are extending rearwards from the connecting face 15 along a mating direction. The insulative housing 1 defines a pair of stopping portions 14 located on a top surface thereof, and the stopping portions 14 are protruding forwards and upwards from the connecting face 15. Each stopping portion 14 defines an engaging hole 141 through thereof along the mating direction.

The contacts 2 are inserted into the terminal passages 12 from the rear end of the insulative housing 1 along the mating direction, with elastic contact portions 21 in the front of the contacts 2 inserted into the trapezoid space 11, and tail portions 23 exposed beyond the connecting face 15 of the insualtive housing 1 to connect with the wires 41. A plurality of barbs 221 are formed on retaining portions 22 in the middle of the contacts 2 to hold the contacts 2 in the insulative housing 1.

The spacer 3 includes a main portion 31 in the front thereof and a sustaining portion 32 extending rearwards from the main portion 31. The main portion 31 defines a pair of coupling slots 311 depressed from a front surface thereof. A central locking tab 312 is arranged on a top surface of the main portion 31, and a pair of ribs 313 are defined on both sides of the locking tab 312, the ribs 313 are extending upwards and forwards from the top surface of the main portion 31, then extruding beyond a front end surface of the main portion. The sustaining portion 32 defines a plurality of grooves 321 receiving the contacts 2 and extending forwards through the main portion 31.

The cable 4 is of flat shape in cross-section substantially in the preferred embodiment of present invention, and has the plurality of wires 41. In other selectable embodiment, the cable 4 can be of round shape or other shapes.

The shell 5 is made of metallic material and comprises a top shell 52, and a bottom shell 51 assembled to the top shell 52 along a direction perpendicular to the mating direction. The bottom shell 51 comprises a frame-shaped base portion 511 and an extension portion 513 extending backwards from the base portion 511. The base portion 511 has a trapezoidal cavity 510 and a top wall 5112 above the cavity 510, the top wall 5112 is extending backwards to form a latching portion 5113, and a latching hole 5114 is arranged in the latching portion 5113. The extension portion 513 has a pair of projections 5131 extending upwards on both sides thereof, and an extrusion 5132 is disposed on each lateral side of the extension portion 513.

The top shell 52 is die-cast in preferred embodiment of the present invention, and comprises a body portion 521 in the front thereof and a sleeve portion 523 extending backwards from the body portion 521. The body portion 521 has an upper wall 5210, a pair of lateral walls 5212 perpendicular to the upper wall 5210 and a rear wall 5213 connected with the lateral walls 5212, the rear wall 5213 is vertical to the upper wall 5210. In other selectiveable embodiment, the lateral walls 5212 can be bent downwards from the upper wall 5210. A receiving hole 5214 is arranged in a connecting area between the upper wall 5210 and each lateral wall 5212. Each lateral wall 5212 defines a through hole 5215, and a pair of obstructions 5216 are bent downwards from a front end of the upper wall 5210. The sleeve portion 523 is extending rearwards from the rear wall 5213 to form a close configuration with four conjoint walls, and the sleeve portion 523 defines a hollow 5230 therethrough along the mating direction. The sleeve portion 523 is of ringed runway shape, and has the same shape as the cable 4 approximatively.

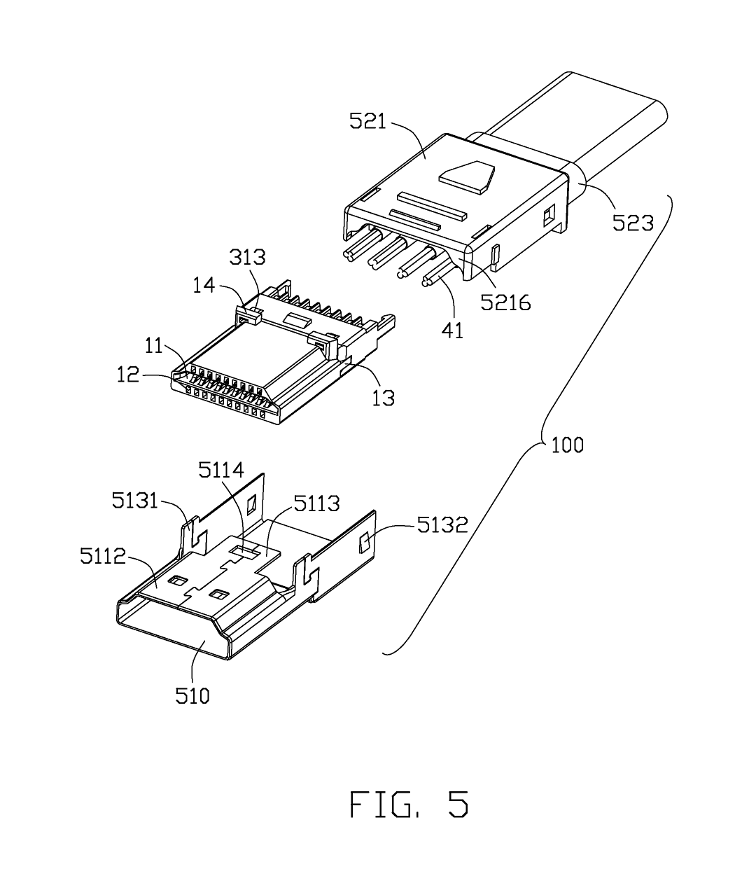

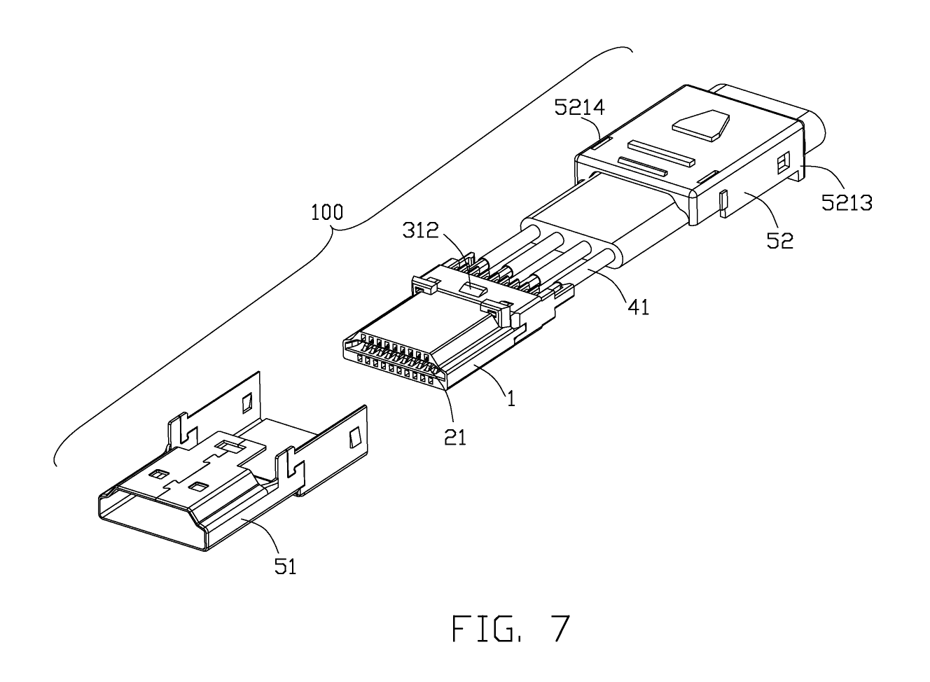

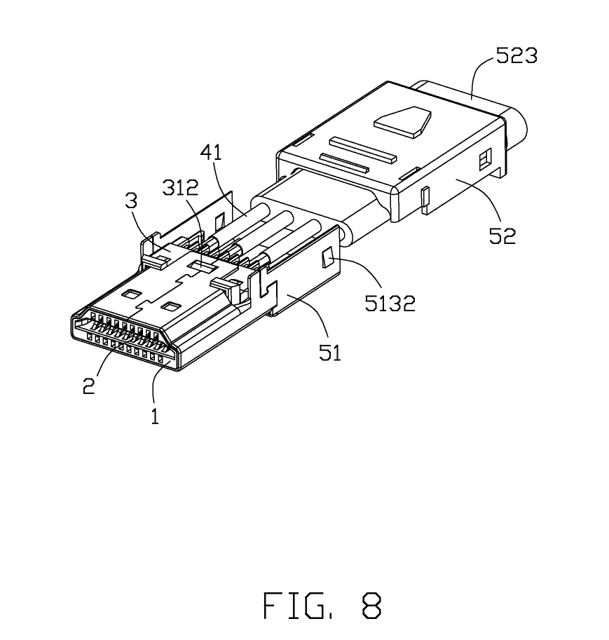

Referring to FIGS. 7-8, in conjunction with FIG. 1, FIG. 3, and FIG. 5, in assembly, the contacts 2 are inserted into the terminal passages 12 of the insulative housing 1 from back-to-front, and the contacting portions 21 are exposed in the trapezoid space 11 of the insulative housing 1. The spacer 3 is assembled to the insulative housing 1 along the rear-to-front direction and adjacent to the connecting face 15 of the insulative housing 1. The tail portions 23 of the contacts 2 are extending through the main portion 31 of the spacer 3, and then received in the grooves 321. The positioning legs 13 on both sides of the insulative housing 1 are accommodated in the coupling slots 311 of the spacer 3. The tabs 313 of the spacer 3 are inserted into the corresponding engaging holes 141 of the insulative housing 1.

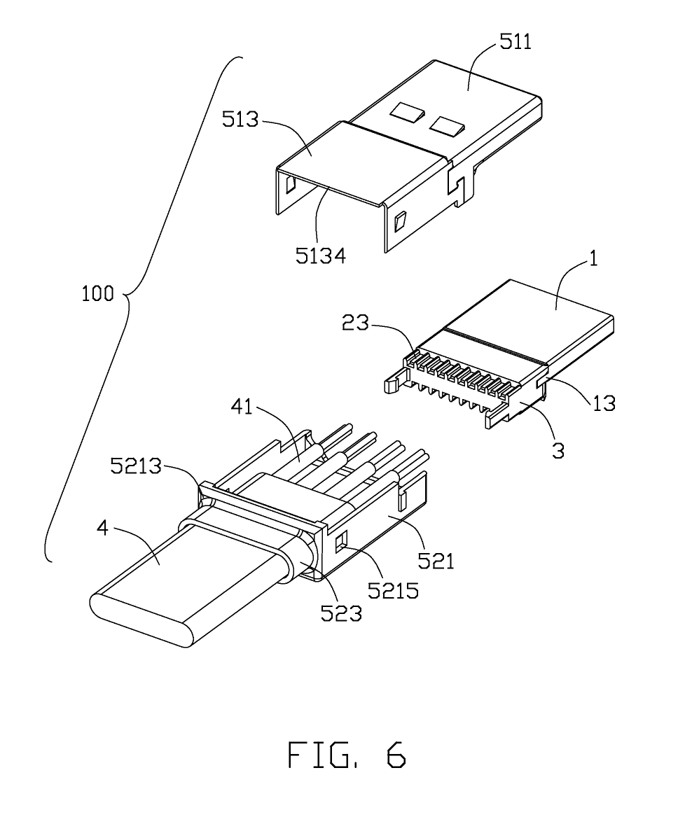

Then the cable 4 is inserted through the hollow 5230 of the sleeve portion 523 of the top shell 52 (shown in FIG. 5), and received in the sleeve portion 523, the wires 41 are soldered to the tail portions 23 of the contacts 2 (shown in FIG. 6) to form an electrical connection. The aforementioned elements are disposed into the bottom shell 51 (shown in FIG. 8) along the rear-to-front direction, the base portion 511 is enclosing the insulative housing 1, and the locking tab 312 is latched in the latching hole 5114 of the latching portion 5113. Then the front section of the top shell 52 is lifted up until the top shell 52 moving forwards to locate above the extension portion 513 of the bottom shell 51, then the front section of the top shell 52 is turned down with respect to the back end of the top shell 52 as a pivot axis, therefore the top shell 52 is assembled to the bottom shell 51. The obstructions 5216 of the top shell 52 are located in front of the corresponding stopping portions 14 of the insulative housing 1, and the projections 5131 of the bottom shell 51 are inserted into the receiving holes 5214 of the top shell 52, the extrusions 5132 are retained in the through holes 5215. After that, the projections 5131 are soldered in the receiving holes 5214 of the top shell 52, a rear edge 5134 of the extension portion 513 is soldered to a lower edge of the top shell 52, to enhance conjunction intensity therebetween.

After a cover molded on the shell 5, the electrical connector assembly 100 is assembled.

It is to be understood, however, that even though numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. An electrical connector assembly, comprising:
an insulative housing with a plurality of terminal passages;
a plurality of contacts received in the corresponding terminal passages; and
a shell enclosing the insulative housing, and having a top shell and a bottom shell assembled with each other;
wherein the top shell includes a body portion in the front thereof and a sleeve portion extending backwards from the body portion, the body portion has an upper wall, a rear wall connected with the upper wall and vertical to the upper wall, and a pair of lateral walls on both sides of the upper wall and perpendicular to the upper wall, the sleeve portion is extending rearwards from the rear wall to form a close configuration with four conjoint walls.

2. The electrical connector assembly as claimed in claim 1, wherein the sleeve portion defines a hollow therethrough along a mating direction.

3. The electrical connector assembly as claimed in claim 2, wherein the electrical connector assembly further comprises a flat cable electrically connected with the contacts, the cable is inserted into and received in the hollow of the sleeve portion.

4. The electrical connector assembly as claimed in claim 3, wherein the hollow and the cable have a same shape as each other in a cross-section.

5. The electrical connector assembly as claimed in claim 1, wherein a receiving hole is arranged in a connecting area between the upper wall and each lateral wall of the top shell, the bottom shell has a pair of projections extending upwards on both sides thereof and inserted into the corresponding receiving holes.

6. The electrical connector assembly as claimed in claim 5, wherein the projections of the bottom shell are soldered in the receiving holes.

7. The electrical connector assembly as claimed in claim 5, wherein each lateral wall of the top shell defines a through hole, and the bottom shell has a pair of extrusions on lateral sides retained in the corresponding through holes.

8. The electrical connector assembly as claimed in claim 1, wherein a pair of obstructions are bent downwards from a front end of the upper wall, and the insulative housing has a pair of stopping portions located on a top surface thereof, the obstructions are located in front of the corresponding stopping portions.

9. The electrical connector assembly as claimed in claim 8, wherein a spacer is assembled to the insulative housing and defines a locking tab, the bottom shell has a latching portion with a latching hole therein, and the locking tab is accommodated in the latching hole.

10. The electrical connector assembly as claimed in claim 9, wherein each stopping portion defines an engaging hole through thereof along the mating direction, and the spacer has a pair of ribs extending upwards and forwards from a top surface thereof, the ribs are extruding beyond a front end surface of the spacer and inserted into the corresponding engaging holes.

11. The electrical connector assembly as claimed in claim 10, wherein the locking tab is sandwiched between the pair of ribs.

12. The electrical connector assembly as claimed in claim 1, wherein the sleeve portion is of ringed runway shape.

13. The electrical connector assembly as claimed in claim 12, wherein the rear wall of the top shell is connected with the lateral walls with no seam.

14. An electrical connector assembly comprising:
an insulative housing defining a front mating portion and a rear connecting portion along a front-to-back direction;
a plurality of contacts disposed in the housing with front contacting sections exposed in the mating portion and a rear connecting sections exposed in the rear connecting portion in said front-to-back direction;
a cable including a plurality of wires side by side, along a transverse direction perpendicular to said front-to-back direction, arranged with one another and connected to the connecting sections of the corresponding contacts, respectively; and
a metallic structure including a first piece and a second piece, said first piece having a front section essentially fully enclosing the mating port and a first middle section, said second piece having rear section essentially fully defining an entrance of and enclosing the cable and a second middle section; wherein
said first middle section cooperates with the second middle section to essentially fully enclose the rear connecting portion of the housing.

15. The electrical connector assembly as claimed in claim 14, wherein the first piece and the second pieces are assembled to each other in a vertical direction perpendicular to both said front-to-back direction and said transverse direction.

16. The electrical connector as claimed in claim 14, further including an insulative spacer located behind the housing to regulate either the connecting sections or the wires.
